(19) United States
(12) Patent Application Publication
(10) Pub. No.: US 2009/0279951 A1
(43) Pub. Date: Nov. 12, 2009

(54) Surface mount traffic channelizer

(76) Inventor: Dale Owen Wheeler, JR., North Canton, OH (US)

Correspondence Address: David E. Wheeler, 1905 Sunrise St. N.W., North Canton, OH, 44720, US

(21) Appl. No.: 12/151,956

(22) Filed: May 12, 2008

(51) Int. Cl. E01F 9/012; E05D 3/02; F16C 11/00

(52) U.S. Cl. 404/10; 16/225; 403/52

(57) ABSTRACT

A Surface Mount Channelizer (40) for more efficiently absorbing impacts to a marker or sign used for demarking traffic lanes provides means for efficiently replacing a flexible shaft without detaching a mounting base from a lane surface. The apparatus comprises an upright marker (10) connected to a mounting base (18, 24), wherein the apparatus has means for providing free movement of marker (10) in any direction relative to mounting base (18, 24). The means for providing free movement comprises a flexible hinge (22), connecting marker (10) to mounting base (18, 24). Marker (10) is preferably comprised of a flexible material, and in combination with flexible hinge (22) is capable of a range of motion from upright to parallel with the ground 360° around said mounting base.

### BACKGROUND OF THE INVENTION

1. Field of the Invention

This invention relates to traffic channelizers, lane markers and signs, and specifically flexible markers and signs with replaceable shafts.

2. Description of the Prior Art

Markers and signs are used on highways to indicate the edge of the road, to channel and control traffic, to warn of hazards, and to provide information about direction or location. Often these markers and signs are positioned where they may be struck by a passing vehicle.

When hit hard enough, or at the wrong angle, a marker shaft may break or become permanently deformed, most frequently at the point where they are attached to a mounting base. It is practical to make the mounting base sturdy enough to survive most such impacts, and designed such that, when necessary, only the flexible shaft needs to be replaced. Preferably the mounting base is designed to permit replacement of the shaft with minimal time, equipment and expense.

Marker posts with flexible elements are disclosed by Hughes in U.S. Pat. No. 4,862,823, which describes a flexible element at the bottom of a marker shaft, designed to absorb the impact of a vehicle, lessening damage to the shaft and the vehicle. The flexible element allows the marker shaft to bend on impact, to the extent that it may be parallel to the ground, and causes the marker to return to an upright position. The '823 patent teaches mounting the flexible element to a post anchored in the ground adjacent to the roadway.

U.S. Pat. No. 4,269,534 to Ryan teaches replacing a marker shaft without detaching a mounting base from a road surface. Ryan does not describe attaching a flexible element to the mounting base.

Hughes, in U.S. Pat. No. 5,197,819 teaches mounting a flexible element to a mounting base, using a hinge that is solidly joined to the baseplate of the mounting base. Locking wedges are positioned in a cavity in the mounting base for surrounding and supporting the marker support shaft. A locking pin locks the wedges and the marker shaft into the marker shaft cavity.

### SUMMARY OF THE INVENTION

An apparatus for marking traffic lanes comprises an upright flexible marker (10) connected to a mounting base (18, 24), the apparatus having means providing free movement of flexible marker (10) in any direction relative to mounting base (18, 24). In the illustrated embodiment, the means for providing free movement in any direction comprises flexible hinge (22) which is capable of bending at about 90° relative to the upright position 360° around mounting base (18, 24). The hinge comprises an upper potion (26), a mid portion (28) and a bottom portion (30), wherein mid portion (28) has a reduced diameter which provides a flexion point, and marker (10) is adapted to fit over upper portion (26) of flexible hinge (22). In the illustrated embodiment the flexible hinge (22) comprises a polyester based urethane elastomer. Mounting base (18) comprises sides (32), a top (48), and mandrel (44) and recess (46) for receiving the flexible hinge (22). Flexible hinge (22) is held in place using pin (62). Mounting base (18) comprises a shell of break resistant material having a crush resistant reinforced structure. In the illustrated embodiment, base (18) comprises acrylonitrile butadiene styrene (ABS).

Also provided are a flexible hinge (22) comprising a top portion (26), a mid-portion (28) and a bottom portion (30), and a mounting base (18). The mid-portion (28) of flexible hinge (22) has a reduced diameter, and a shoulder (38) delineating top portion (26). The flexible hinge has a least one hole (60) for receiving a pin (62) for attaching an upright marker or post to the flexible hinge. The flexible hinge is made of an elastic material. Mounting base (18) comprises a shell of break resistant material which has a crush resistant structure.

### BRIEF DESCRIPTION OF THE DRAWINGS

FIG. 1 illustrates a channelizer (40) of the invention comprising a marker (10) connected to flexible hinge (22), flexible hinge (22) being fixed to a mounting base (24).

FIG. 2 illustrates an alternative mounting base (18).

FIG. 3 illustrates a bottom view of the mounting base (18) shown in FIG. 2.

FIG. 4 illustrates a frontal view of a flexible hinge (22).

FIG. 5 illustrates a section view of flexible hinge (22) taken along line A-A of FIG. 4.

FIG. 6 illustrates a side view of flexible hinge (22).

FIG. 7 illustrates an exploded view of channelizer (40).

### DETAILED DESCRIPTION OF THE INVENTION

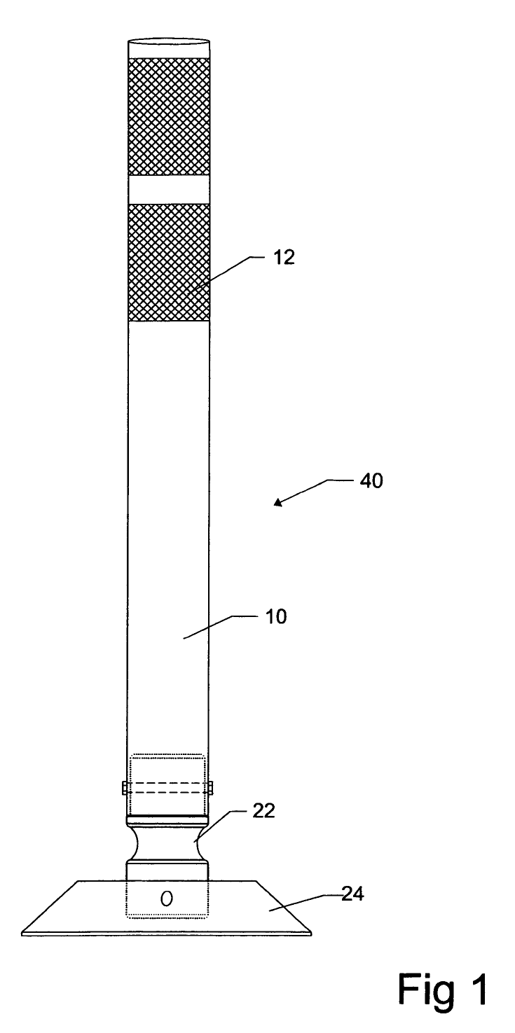

With reference now to FIG. 1, in the illustrated embodiment, the invention comprises an upright marker (10) connected to a mounting base (24). Mounting base (24) comprises a base plate having means for attaching mounting base (24) to a paved or concrete surface, or other surface adapted to handle pedestrian, vehicle, cart or any kind of mechanized traffic. Mounting base (24) may be attached to the surface using an adhesive which may be applied to the base plate or the traffic surface, or may be bolted to the surface, or held in place by any other means know to those skilled in the art. In the illustrated embodiment, a thermoplastic adhesive pad or a flexible mastic adhesive is used.

Marker (10) is preferably made of a flexible material, and is preferably fluorescent, lighted or adorned with reflectors (12). In the embodiment shown in FIG. 1, marker (10) has a hollow tubular structure that is adapted to slide over flexible hinge (22).

In the illustrated embodiment, marker (10) may comprise any plastic, elastomeric or thermoplastic elastomer having properties suitable for its intended use. Marker (10) is designed to be resistant to ultraviolet light, ozone and hydrocarbons. It is also resistant to impact in conditions from minus 20° F. to 120° F. Marker (10) has a minimum tensile strength of 1500 pounds per square inch, and a tensile stress within industry specifications as determined by Standard Method of Test for Tensile Properties of Plastic, ASTM D638.

Marker (10) may comprise any polymeric, thermoplastic or elastomeric material having properties suitable for the purpose for which it is used. Preferably the material will be of a kind, or contain additives which glow in the dark. Examples of the material which may be used are polyesters, polyolefins, polyamides, polyethers, mixtures thereof, and thermoplastic resins which include crystallizable polyolefins, polyimides, polyamides (nylons), polyesters, poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, and fluorine-containing thermoplastics. The preferred thermoplastic resins are crystallizable polyolefins that are formed by polymerizing alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof For example, known polyethylene homo- and copolymers having ethylene crystallinity are suitable. Isotactic polypropylene and crystallizable copolymers of propylene and ethylene or other C₄-C₁₀ alpha-olefins, or diolefins, having isotactic propylene crystallinity are preferred. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof are also suitable. These will include reactor polypropylene copolymers and impact polypropylene copolymers, whether block, random or of mixed polymer synthesis. These homopolymers and copolymers may be synthesized by using any polymerization technique known in the art such as, but not limited to, the “Phillips catalyzed reactions,” conventional Ziegler-Natta type polymerizations, and organometallic single-site olefin polymerization catalysis exemplified by, but not limited to, metallocene-alumoxane and metallocene-ionic activator catalysis. In the illustrated embodiment, high density polyethylene (HDPE )is used.

In the preferred embodiment, reflector (12) will comprise an impact resistant band of reflective sheeting with pressure sensitive backing. Those skilled in the art will recognize that suitable alternative means for applying reflectors are known in the art. The reflector is generally at least three inches wide, and usually about two inches from the top of marker (10) in accordance with MUTCD standards. Marker (10) may be 2.25 to three inches in diameter and will preferably be white, yellow or orange, also in accordance with MUTCD standards.

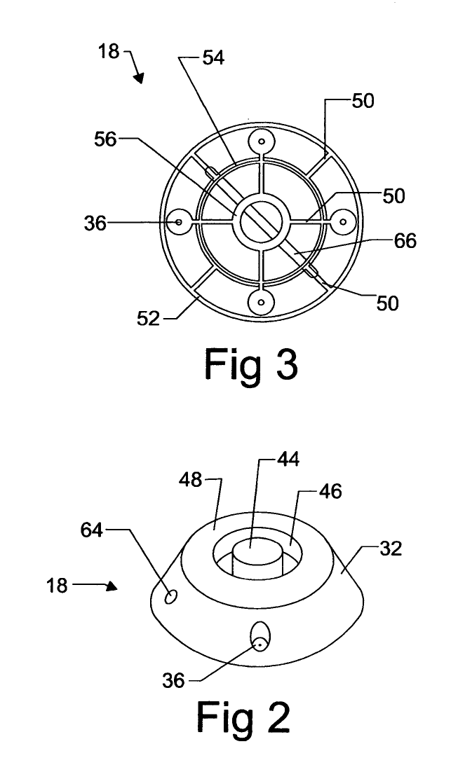

With reference now to FIGS. 2 and 3, an alternative mounting base (18) may comprise a circular structure with inclined sides (32) which provide a ramp for directing a vehicle tire up and over mounting base (18), reducing impact in the case where a vehicle tire strikes mounting base (18). Mounting base (18) has a top surface (48), a center mandrel (44) and recess (46) for receiving flexible hinge (22). With reference specifically to FIG. 3, mounting base (18) has means for attaching mounting base (18) to a paved surface using connectors through holes (36). Similar mounting bases known in the art are made solid and are very heavy, and may weigh five pounds or more. To reduce weight, mounting base (18) comprises a rim (52), a reinforcing outer ring of material (54), and a broader central inner ring of material (56) which corresponds to the bottom of mandrel (44) and recess (46). Support struts (50) connect outer reinforcing ring of material (54), rim (52), and center ring of material (56) to form a honeycomb structure that provides great strength, while using a minimal amount of material.

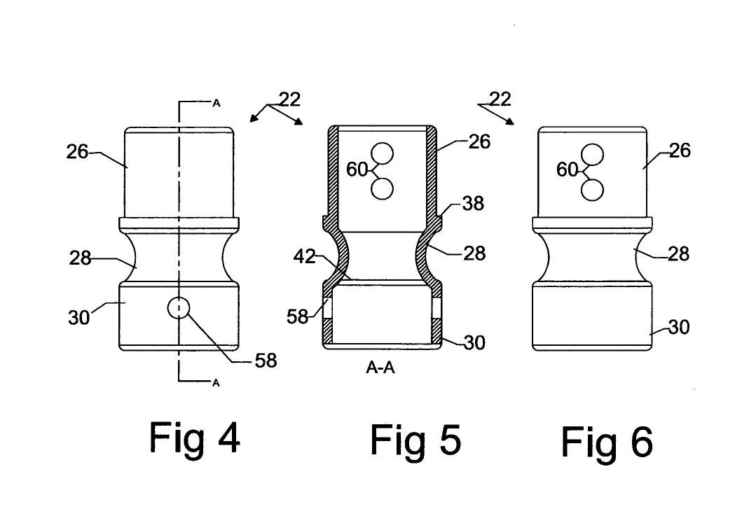

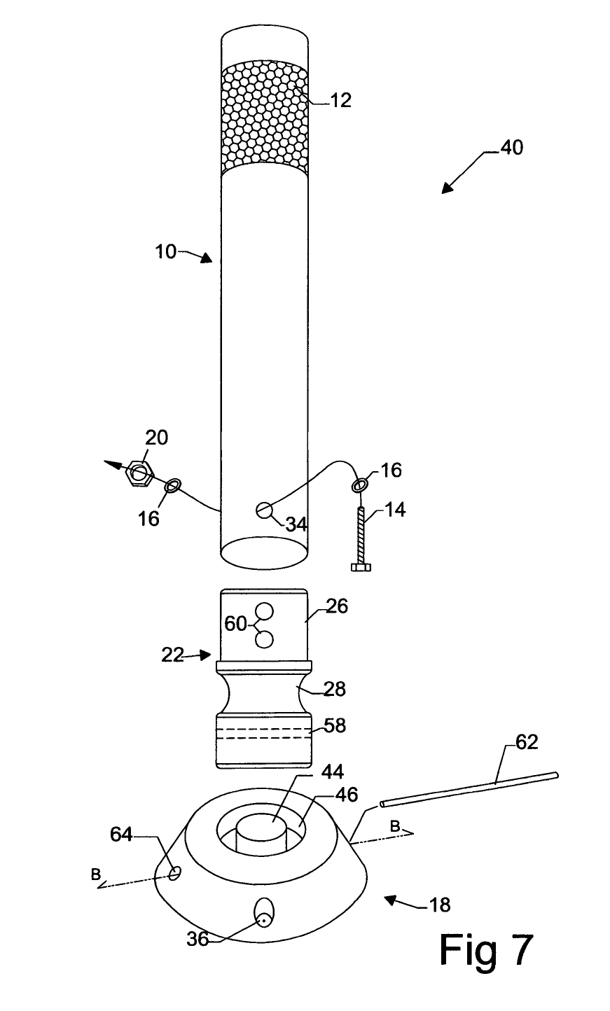

With reference now to FIGS. 4 through 6, a flexible hinge (22) comprises a top portion (26), a mid-portion (28) and a bottom portion (30). With reference to FIG. 7, shoulder (38), delineating top portion (26), may provide a stop for flexible marker (10) as it slides onto flexible hinge (22). In the illustrated embodiment, marker (10) is held in place by a bolt (14) which is held in place by flat washers (16) and locking nut (20). At least one bolt (14) passes through marker (10) through a hole (34), and through a hole (60) in flexible hinge (22). Shoulder (38), delineating the area between upper portion (26) and mid portion (28) may be used as a stop for marker (10), to make it easier to line up hole (34) and hole (60). Alternatively, those skilled in the art will recognize that flexible marker (10) may be molded with a smaller diameter end that can be placed within flexible hinge (22) toward inside diameter shelf (42). Flexible hinge (22) is preferably made of an elastic material, preferably an elastomer having durability, flexibility, impact resistance and other durability requirements as defined for marker (10) as described herein.

In the illustrated embodiment, flat washer (16) are used to protect the polymeric materials used to make marker (10), and a lock nut (20) is used to hold marker (10) in place. Those skilled in the art will recognize that lock washers and conventional nuts can be used.

In the illustrated embodiment, bottom portion (30) of flexible Hinge (22) is adapted to fit over mandrel (44) and within recess (46) of mounting base (18). Shelf (42), delineating mid portion (28) and bottom portion (30) may be engineered to provide a stop for flexible hinge (22) on mandrel (44) to help line up hole (58) in bottom portion (30) with pin hole (64) through pin sheath (66) along line B-B in mounting base (18). Pin (62) is placed through pin hole (64), and through hole (58) to hold flexible hinge (22) firmly on mandrel (44).

The hinge (22) is preferably an elastomer or mixtures of elastomers and polymeric materials, and may comprise butyl rubber, and similar rubbers known to those skilled in the art, formulated for the properties described. Preferred elastomers are those prepared from copolymers of C₄₋₇ iso-olefins and para-alkylstyrene, and polyesters and polycarbamates. The former copolymers are more fully described in U.S. Pat. No. 5,162,445, the disclosure of which is incorporated herein by reference. A particularly preferred elastomer species is represented by the halogenated copolymer of isobutylene and para-methylstyrene. Elastomers of ethylene-propylene (EPR) and poly(ethylene-co-propylene-co-diene), also known as EPDM rubber, have sufficient flexibility, either alone or in combination with copolymers of isoolefins and para-alkylstyrene. As used herein, reference to an elastomer includes a mixture of two or more elastomers. Unsaturated rubbers include monoolefin copolymer rubbers comprising non-polar, rubbery copolymers of two or more monoolefins (EPR rubber), preferably copolymerized with at least one polyene, usually a diene (EPDM rubber). EPDM is a polymer of ethylene, propylene and one or more non-conjugated diene(s), and the monomer components may be polymerized using Ziegler-Natta or metallocene catalyzed reactions. Other catalysts systems such as the Brookhardt catalyst system may also be employed. Satisfactory non-conjugated dienes include 5-ethylidene-2-norbornene (ENB); 1,4-hexadiene (HD); 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; dicyclopentadiene (DCPD); 5-vinyl-2-norbornene (VNB); 5-vinyl-2-norbornene, divinyl benzene, and the like, or a combination thereof. In the illustrated embodiment the hinge comprises a polyester based urethane elastomer.

In the illustrated embodiment, mid-portion (28) has a reduced diameter, which provides a flexion point. Flexible hinge (22), when a vehicle hits marker (10) with a glancing blow, is capable of bending in any direction.

In the illustrated embodiment, mounting base (24) will have a maximum height of about 1.875 inches.

Marker (10) is capable of deflection in any direction, for any amount needed, up to and including a 90° bend, i.e. substantially parallel to the ground. This flexibility reduces the chances that marker (10) will be damaged in a collision, and reduces the chances that a vehicle that strikes marker (10) will be damaged. In the meantime, marker (10) is substantial enough to cause a thumping sound when it is hit, to provide notice to a driver, when a driven vehicle is used, that he is outside the lane.

Mounting base (18) needs to be a wear and break resistant material, and may be an elastomer or a rigid polymer. Material which may be use in mounting base (18) include polyvinyl chloride, polyamides, polyolefins, polyesters, EPDM rubber, thermoplastic resins as described for marker (10) and mixtures thereof, as well as similar materials known in the art with similar properties. In the illustrated embodiment the base comprises acrylonitrile butadiene styrene.

The channelizer (40) of the invention is capable of withstanding, on average, about 25 impacts at 55 mph by an average sized American automobile.

The described structure makes it possible for a quick and inexpensive repair when a marker is damaged, since the lock nut (20), flat washers (16), and bolt (14) may be removed from a broken or damaged marker, and the marker removed and a new one put in its place. This is particularly important when the markers are in use on a busy highway. When more extensive repairs are needed, flexible hinge (22) can be easily removed from mounting base (18) by removing pin (62), and repairs to the whole assembly can be made in a safe location.

### EXAMPLES

### Example 1

Channelizers of the invention were positioned in a vertical position on a solid surface and conditioned for a minimum of two hours at 3 to 120° F. Marker (10) was bent at 90° such that the marker end touched the floor surface. The marker returned to within 5° of the upright position within 15 seconds. The bend test was repeated three times in quick succession, completing the test within 2½ minutes of removing the channelizer from the condition temperature.

### Example 2

The test described in Example 1 was repeated using a conditioning temperature of −20° F.

### Example 3

A hollow polymeric tube used in the construction of marker (10) was conditioned at −20° F. for two hours. The marker was struck flush against a flat surface 3 times within 2 minutes after being removed from the conditioning chamber by swinging it through a 90° arc. The tube did not fracture or shatter on impact.

While an embodiment of the invention has been illustrated particularly with reference to highway use, those skilled in the art will recognize that the invention can be used anywhere where lane demarcation is desired. For example, the markers can be used in parking lots, in supermarkets, movie theaters, golf courses, department stores, mall areas and any other places where pedestrians, vehicles or carts are used. Also, while particular materials have been illustrated for use in the invention, those skilled in the art will recognize that polymer engineers and rubber engineers have materials available, or have the ability to engineer materials which can be used, based on the physical requirements described. While the invention has been specifically illustrated and described, those skilled in art will recognize that the invention can be variously modified and used within the bounds of the claims.

What is claimed is:

1. An apparatus for marking traffic lanes comprising an upright flexible marker (10) connected to a mounting base (18, 24), said apparatus having means providing free movement of flexible marker (10) in any direction relative to mounting base (18, 24).

2. The apparatus of claim 1 wherein said means for providing free movement in any direction comprises flexible hinge (22) which is capable of bending at about 90° relative to the upright position 360° around mounting base (18, 24).

3. The apparatus of claim 2 wherein said hinge comprises an upper potion (26), a mid portion (28) and a bottom portion (30), wherein mid portion (28) is a reduced diameter flexion point.

4. The apparatus of claim 3 wherein marker (10) is adapted to fit over upper portion (26) of flexible hinge (22).

5. The apparatus of claim 3 wherein said flexible hinge (22) comprises a polyester based urethane elastomer.

6. The apparatus of claim 1 wherein said mounting base (18) comprises sides (32), a top (48), mandrel (44) and recess (46) for receiving a flexible hinge (22).

7. The apparatus of claim 6 wherein flexible hinge (22) is held in place using pin (62).

8. The apparatus of claim 1 wherein mounting base (18) comprises a shell of break resistant material having a crush resistant reinforcing structure.

9. The apparatus of claim 8 wherein mounting base (18) comprises acrylonitrile butadiene styrene.

10. A flexible hinge for a channelizer (40) comprising an upper potion (26), a mid portion (28) and a bottom portion (30), wherein mid portion (28) is a reduced diameter flexion point.

11. The apparatus of claim 10 wherein a shoulder (38) and a shelf (42) provide reference points for alignment of marker (10) and a mandrel (44).

12. The apparatus of claim 10 wherein said flexible hinge (22) comprises a polyester based urethane elastomer.

13. A mounting base (18) comprising sides (32), a top (48), and a recess (46) centrally located in top (48), said recess containing a mandrel (44) for receiving a flexible hinge (22).

14. The mounting base of claim 13 wherein a flexible hinge (22) is held in place using pin (62) passing through mounting base (18) and flexible hinge (22).

15. The mounting base of claim 13 wherein said mounting base (18) comprises a shell of break resistant material having a crush resistant reinforcing structure.

16. The apparatus of claim 13 wherein mounting base (18) comprises acrylonitrile butadiene styrene.
